(19) United States
(12) Patent Application Publication
(10) Pub. No.: US 2024/0124188 A1
(43) Pub. Date: Apr. 18, 2024

(54) CONTAINER AND DISPENSER

(71) Applicant: Parcel Health, Inc., Ypsilanti, MI (US)

(72) Inventors: Alex Nunes BARRETTE, Richmond, VA (US); Mallory Walsh BARRETT, Richmond, VA (US); Melinda Su-En LEE, Pittsburgh, PA (US); Tyler Lewars WRIGHT, Teaneck, NJ (US); Victor Chan LE, Westminster, CA (US)

(21) Appl. No.: 18/274,474

(22) PCT Filed: Feb. 1, 2022
(86) PCT No.: PCT/US2022/014797

§ 371 Date: Jul. 27, 2023

Related U.S. Application Data
(60) Provisional application No. 63/144,543, filed on Feb. 2, 2021.

(51) Int. Cl. B65D 5/72; B31B 50/26; B65D 5/38; B65D 65/38

(52) U.S. Cl. CPC B65D 5/728; B31B 50/262; B65D 5/38; B65D 65/38; B31B 2110/35

(57) ABSTRACT

A container device and methods of operation and assembly of the same are provided. The container device is formed from a foldable material and includes interior locking mechanisms that prevent an inner box from being removed from an outer cover unless a user depresses a portion of the outer box to disengage an internal locking mechanism. A secondary locking mechanism prevents the inner box from being removed entirely from the outer cover.

### CROSS-REFERENCE TO RELATED APPLICATIONS

This application claimed the priority benefit of U.S. Provisional Application No. 63/144,543, filed Feb. 2, 2021, the disclosure of which is incorporated in its entirety for all purposes.

### BACKGROUND

Containers for holding and dispensing medications and the like typically come in one of several forms. For example, a plastic bottle with a child-protective cap may be used. As another example, individual doses of medication may be sealed in “blister packs” of plastic, foil, or other materials that allow a patient to dispense a single dose of medication while leaving unused doses sealed in the original package.

### SUMMARY

Embodiments disclosed herein provide containers suitable for holding and dispensing medications, vitamins, supplements, and the like, though its usage is not limited thereto. The container may be fabricated from a recyclable material such as paper, cardstock, cardboard, or the like. The material may be coated or otherwise treated to provide waterproofing or otherwise prevent or reduce the ability of water or other external material to penetrate the container, and/or to prevent or reduce other environmental damage. Containers disclosed herein also may include various locking mechanisms that prevent the containers from being opened unless first placed in a specific arrangement and/or unless a user actively disengages the mechanism.

### BRIEF DESCRIPTION OF THE DRAWINGS

FIG. 1A-1D and 2A-2B show a container as disclosed herein, which includes two separate parts that are connected by placing one inside the other to form the container, including an outer cover and an inner box. FIGS. 1A-1D show view of an example of an outer cover; FIGS. 2A-2B show views of an example of an inner box with locking flaps.

FIG. 1A shows a perspective view of the outer cover. FIG. 1B shows a side view of the outer cover shown in FIG. 1A. FIG. 1C shows another perspective view of the outer cover with the top-most portion open, for example prior to filling and/or sealing the container. FIG. 1D shows a side view of the outer cover with the interior flaps 140 unfolded and extending from the bottom, open end of the outer cover.

FIGS. 2A and 2B show perspective views of the inner box as disclosed herein. FIG. 2A shows the flaps of the inner box extended away from the box opening, prior to the flaps being folded down to allow for insertion of the inner box into the outer cover. FIG. 2B shows the flaps folded down and configured to be inserted into the outer cover.

FIGS. 3A-3C show a side cut-away schematic view of a container as disclosed herein, after the inner box has been inserted into the outer cover and partially removed from the outer cover. Specifically, FIG. 3A shows the inner box fully inserted into the outer cover, where the inner box blocks the opening of the outer cover and thus nothing is dispensed from the inner box; FIG. 3B shows the inner box after the primary flap of the inner box has been disengaged with an interior portion of the outer cover ; and FIG. 3C shows the inner box partially removed from the outer cover, so that materials in the inner box can be dispensed through the opening in the outer cover.

FIGS. 3D-3G show side cut-away schematic views of a container as disclosed herein after the inner box has been inserted into the outer cover, showing another arrangement of the interlocking mechanism of the primary flap of the inner box with a folded portion of the outer cover. FIG. 3D shows the inner box inserted partially into the outer cover. FIG. 3E shows the inner box fully inserted into the outer cover sufficiently to allow for the locking mechanism to be disengaged. FIG. 3F shows the locking mechanism being disengaged by a depressed button on the outer cover. FIG. 3G shows the inner box removed from the outer cover.

FIG. 4A shows an example of an outer cover as disclosed herein in a planar configuration before being folded to form an outer box as shown in FIGS. 1 and 3.

FIG. 4B an example of an inner box as disclosed herein in a planar configuration before being folded to form an outer box as shown in FIGS. 2 and 3.

FIGS. 5A, 5B, and 5C show a process for forming an outer cover as disclosed herein.

FIGS. 6A and 6B show a process for forming an inner box as disclosed herein.

### DETAILED DESCRIPTION

Embodiments disclosed herein provide containers for storing and dispensing medications, vitamins, supplements, and the like, which may be fabricated from cardboard, cardstock, paper, or the like. The containers disclosed herein generally include an outer cover and an inner box that can be placed into the outer cover. Various techniques may be used in the construction and arrangement of the two components to allow for features such as locking mechanisms, openings for filling and dispensing, convenient and simple sealing mechanisms, and other features.

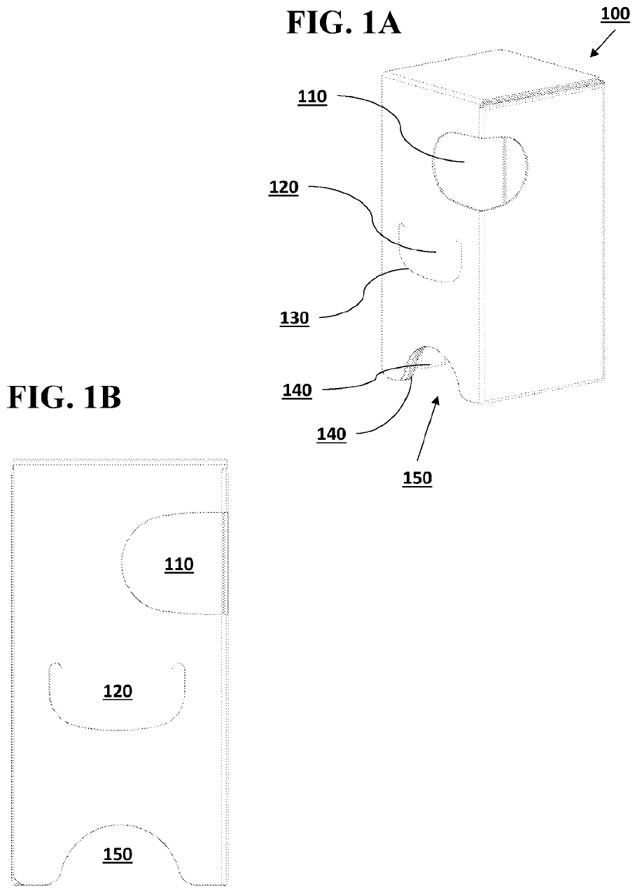

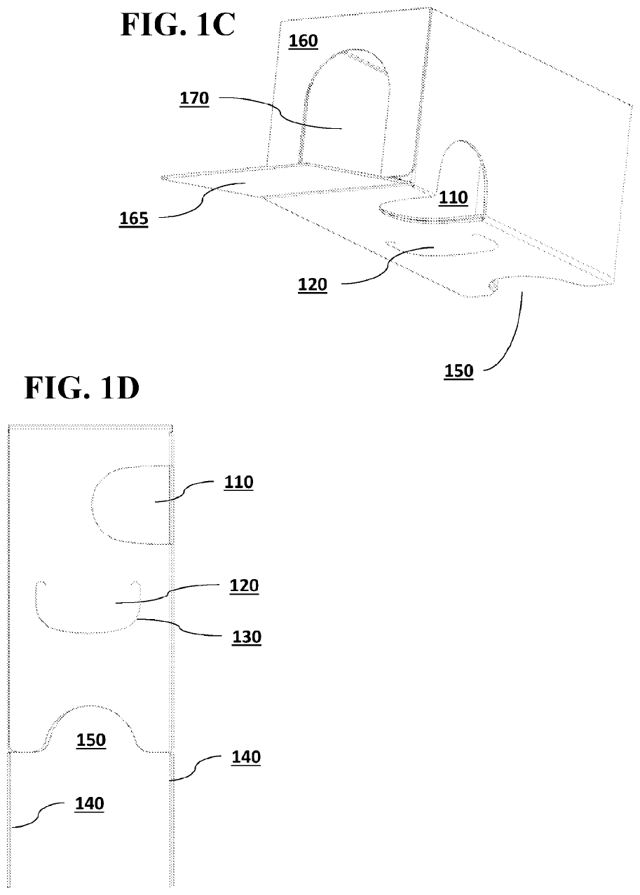

Referring to FIGS. 1A-1D, the outer cover 100 may be generally rectangular in shape and may have a rectangular (including square) cross-section taken across its width (left to right in FIG. 1), and a rectangular cross section across height (top to bottom as shown in FIG. 1). It may include an opening 110 in one edge and adjoining surfaces to allow for contents to be dispensed from the inner box. Alternatively, the opening 110 may be disposed on one face surface of the outer cover, and/or multiple such openings may be used. The outer cover 100 may be, for example, about 1-2 inches square in cross-section, with a height of about 2-4 inches, though any desired relative and absolute dimensions may be used. Specific dimensions may be selected for specific uses and distribution scenarios. For example, the outer cover 100 may be dimensioned to fit in storage or delivery units designed to hold conventional medicine bottles to aid in use by pharmacies, doctors, and the like. In one example embodiment, the outer cover 100 may be about 1.5 inches square in cross section, with a height of about 3 inches.

The outer cover 100 also may include a flexible area that provides a “button” 120, which can be depressed into the interior of the cover and may be defined by a relief cut 130 in the outer cover 100. The relief cut may extend entirely through the outer cover 100 , or it may be partial cut that only extends through some but not all of the thickness or layers (where multiple layers are used) of the outer cover 100. The cover 100 may include one or more lips or interior flaps 140 disposed at one or more edges proximate to the open end of the cover to engage with flaps of the inner box as described below. These interior flaps may prevent the inner box from being removed completely from the outer cover 100 by engaging with corresponding flaps on the inner box. Accordingly, the container may easily open only far enough so as to uncover the opening that allows contents of the container to be dispensed, after which the interlocking flaps may prevent the inner box from being further removed from the outer cover 100. By selecting different sizes for the interior interlocking flaps, different openings may be accommodated in a standardized container size, or different opening sizes may be used with different container sizes. It may be preferable for the inner box to be removable from the outer cover 100 only as far as necessary to expose some, most, or all of the opening and thereby allow contents of the box to be dispensed. The outer cover 100 may include one or more “notches” or other cutout 150 to allow for the inner container to be easily grasped.

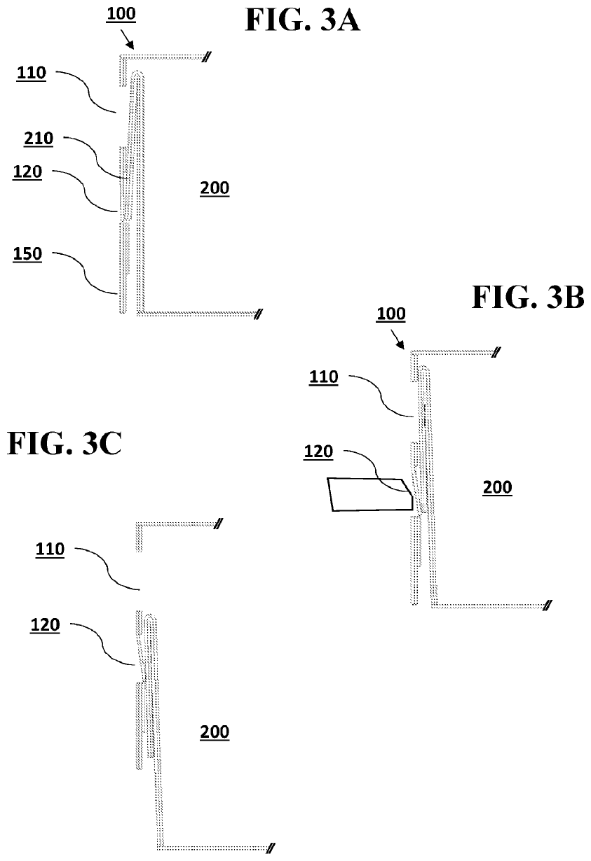

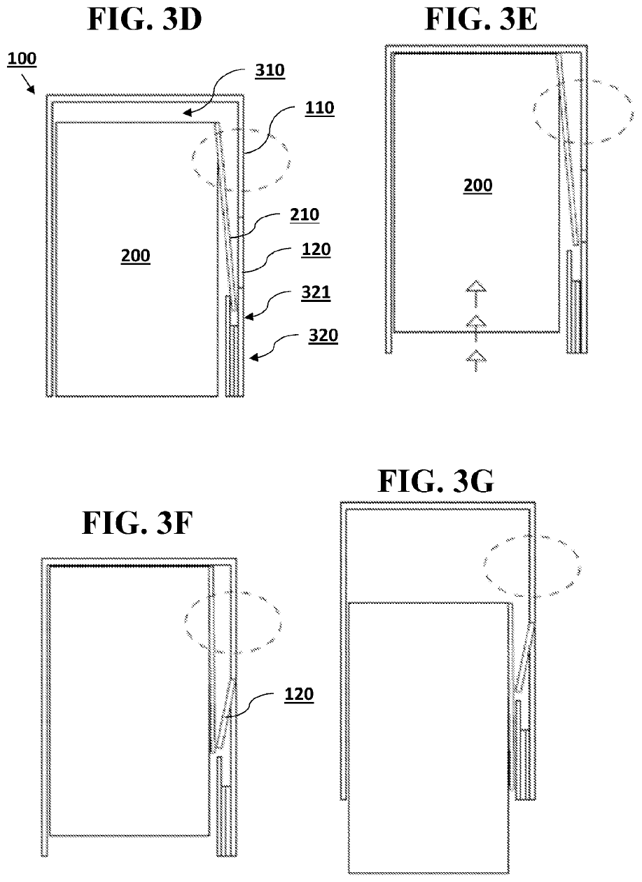

The outer cover 100 and the inner box may lock together using flaps that are folded to nest, such that the interior flap(s) 140 of the outer cover 100 engage with the secondary flap(s) 220 to the inner box to prevent the interior box from being completely removed from the outer cover 100 (absent an excessive application of force sufficient to damage or destroy the container.) As previously disclosed, it may be preferable for the dimensions of the inner box, outer cover 100, and the container as a whole to be selected such that the inner box may be removed from the outer cover 100 sufficiently far to expose the opening through which contents of the container may be dispensed. The specific dimensions may be selected relative to the size of the container and expected contents. The primary flap 210 of the inner box is held under tension once the outer cover 100 locks over the inner box. The outer cover 100 has a third ply folded into the outer cover 100 and a scraped-out recess in the second ply to house the primary flap 210 held under tension. This locks the box from being able to be pulled unless and until the button 120 is depressed while simultaneously pulling on the inner box to engage and open the box. This allows the inner box to be partially removed from the outer cover 100, sufficient to reveal the opening 110 which normally is blocked by a portion of the inner box. Once the opening 110 is no longer blocked by the inner box, medicine or other contents of the inner box may be dispensed through the opening 110. Alternatively or in addition, it may be desirable for the inner portion of the outer cover to include an additional locking mechanism to prevent the button from being depressed unless the inner box is placed into a specific configuration, for example as shown and described with respect to FIGS. 3D-3G.

The opening 110 may be disposed along an edge of the outer cover 100 as shown for ease of pouring contents of the box, such as medications and the like. Alternatively, the opening may be disposed entirely in one surface of the outer cover 100. As will be apparent from the drawings and description provided herein, either configuration may be used successfully, though an edge placement as shown may be preferred for ease of dispensing.

When a container as disclosed herein is in its “open” position, i.e., the inner box has been removed from the outer cover far enough to dispense contents of the container, the outer cover can be pushed back into place to return the container to its closed state, i.e., so that the “button” re-engages with the inner box. The container may be re-opened again by depressing the button as previously disclosed, and the container may be opened and closed any number of times.

Referring to FIG. 1C, an opening 170 may be used to fill the inner box prior to final assembly and sealing. During assembly, adhesive or other sealing or connecting material may be applied in the region 160 to secure the top 165 when folded down, to form the closed end of the outer cover.

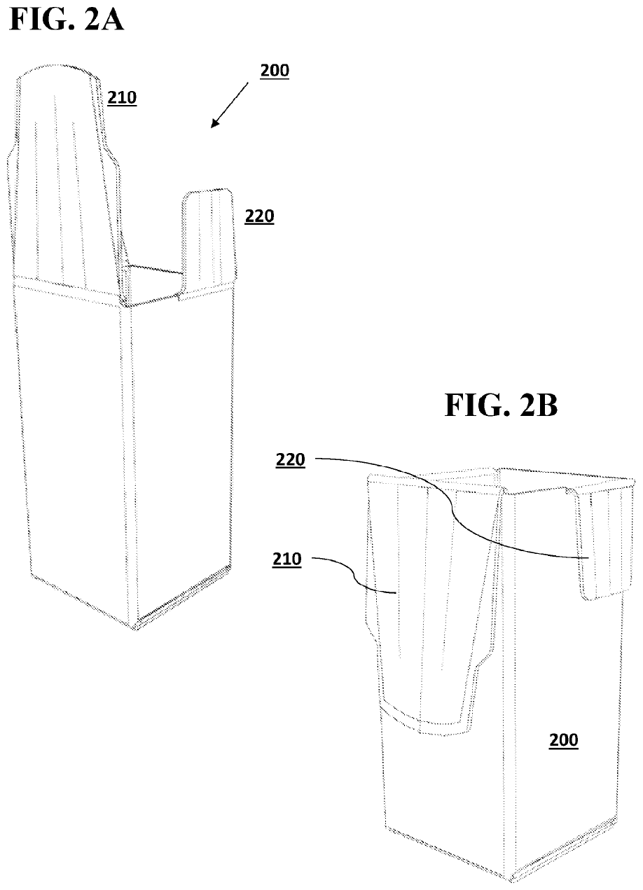

FIGS. 2A-2B show an example inner box 200 according to embodiments disclosed herein, which may be inserted into the open end of the outer cover 100. The inner box 200 may include a primary flap 210 and one or more secondary flaps 220. As described in further detail below, the primary flap 210 may engage with an inner portion of the outer cover 100 to prevent the inner box 200 from being partially removed from the outer cover 100 unless and until the button 120 is depressed into the interior of the outer cover 100, thereby pushing the primary flap 210 away from the outer cover 100. Any desired relative and absolute dimensions may be used as long as the inner box fits snugly within the outer cover 100 but with sufficient room for the flaps to engage as disclosed herein and thereby prevent unintentional opening of the container. In an example embodiment, the inner box 200 may be about 1.4 inches in cross section and about 2.75 inches tall. Other dimensions may be used to accommodate, for example, labels of varying size and shape.

In FIG. 2A, the flaps 210, 220 are in an extended position resulting, for example, after the inner box has been folded or otherwise constructed, but before the flaps are folded down for insertion into the outer cover. FIG. 2B shows the inner box with the flaps 210, 220 folded down and ready to be inserted into the outer cover. Once fully inserted, the primary flap 210 will engage with an interior portion of the outer cover to prevent the inner box from being partially removed from the outer cover unless and until the button 120 on the outer cover is depressed to disengage the primary flap 210 from the inner portion of the outer cover. Similarly, one or more interior flaps 140 of the outer cover as shown in FIGS. 1A-1D will engage with the secondary flaps 220 of the inner box to prevent the inner box from being completely removed from the outer cover even after the button 120 has been depressed as previously disclosed.

FIGS. 3A-3C show, respectively, examples of the inner box fully inserted, partially inserted/removed, and at the farthest partially-removed point allowed by the interlocking flaps as previously described.

In FIG. 3A, the inner box 200 is fully inserted, or essentially fully inserted, into the outer cover 100. In this configuration a portion of the inner box 200 blocks the dispensing opening 110, so that medications or other items or materials contained in the inner box cannot be removed via the opening 110. The primary flap 210 is in a locked configuration that prevents the inner box 200 from being removed from the outer container 100.

FIG. 3B shows the button portion 120 in a depressed configuration, which pushes the primary flap 210 inward, into an unlocked position. This allows the inner box to be pulled outward from the outer cover (toward the bottom of the page in this example). In FIG. 3C, the inner box 200 has been moved out of the outer cover to a sufficient extent to expose the opening 110 to the interior of the inner box 200, thereby allowing items in the inner box 200 to be removed via the opening 110.

FIGS. 3D-3G show another view of a locking mechanism as disclosed herein. As previously disclosed, an inner box 200 is disposed inside an outer cover 100. The inner box 200 and outer cover are shown as closed rectangles and solid lines for clarity, but it will be understood that, as previously disclosed, the top and/or side of the inner box preferably includes an opening allowing materials in the inner box to be removed via the opening in the inner box (not shown) and an opening 110 in the outer cover as previously disclosed.

Referring to FIG. 3D, a schematic view of the outer cover 100 and inner box 200 is shown in a locked position. The inner box 200 includes a primary flap 210 as previously disclosed, which catches on an inner portion 310 of the outer cover 100 to prevent the container from being opened unless the button 120 is depressed, as previously disclosed. In this example, the inner portion 310 is provided by a series of gate-fold or z-fold layers of the outer cover. The example in FIGS. 3D-3H also may include one or more secondary flaps to prevent the inner box from being completely removed from the outer cover as previously disclosed, but such are omitted from FIGS. 3D-3H for clarity.

In FIG. 3D, the container is in a closed and locked state, i.e., the inner box cannot be removed from the outer cover sufficiently far to dispense any contents of the inner box via the opening 110. In this arrangement, the inner box can move a partial distance 310 out of the outer cover 100, but throughout this distance the inner box cannot be removed even if the button 120 is depressed to push on the primary flap 210. The inner portion 320 includes a locking mechanism 321 that prevents the primary flap 210 from being disengaged from the inner portion 310. The inner portion 320 may be formed, for example, from interior flaps 140 formed as a portion of the outer cover as previously disclosed. To release this locking mechanism, the inner box 200 is pushed farther into the outer cover 100 as shown in FIG. 3E, optionally all the way into the outer cover to reduce the inner space 310 to zero or essentially zero, or to some other distance that may be defined, for example, by other internal stops or locks provided by other folds or similar features of the outer cover.

FIG. 3F shows the same arrangement as FIG. 3E, with the button 120 depressed to move the primary flap 210 to an unlocked position as previously disclosed, which is possible because the inner box is pushed sufficiently far into the outer cover to disengage the locking mechanism 321 as previously disclosed. In FIG. 3G, the inner box has been removed from the outer cover sufficiently to allow materials to be dispensed through the opening as previously disclosed.

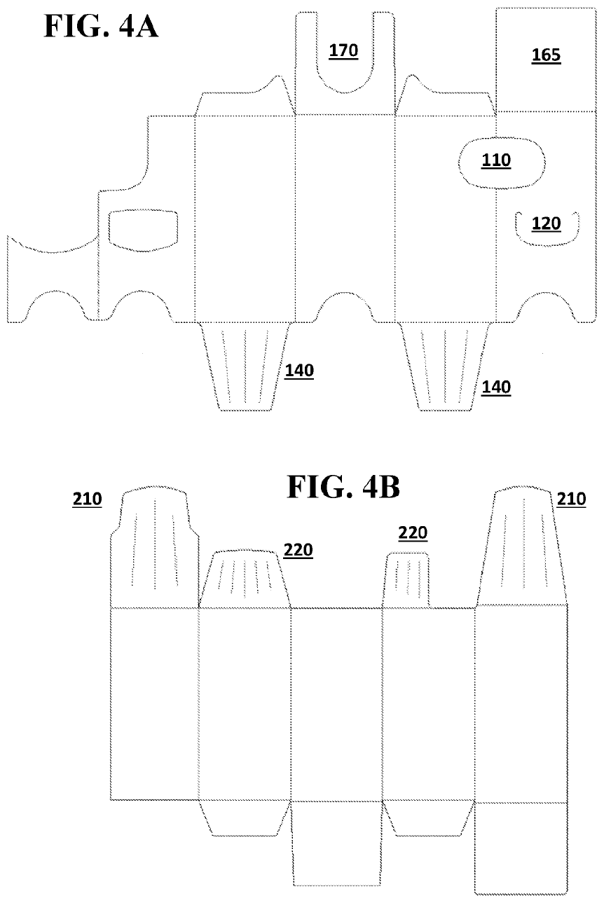

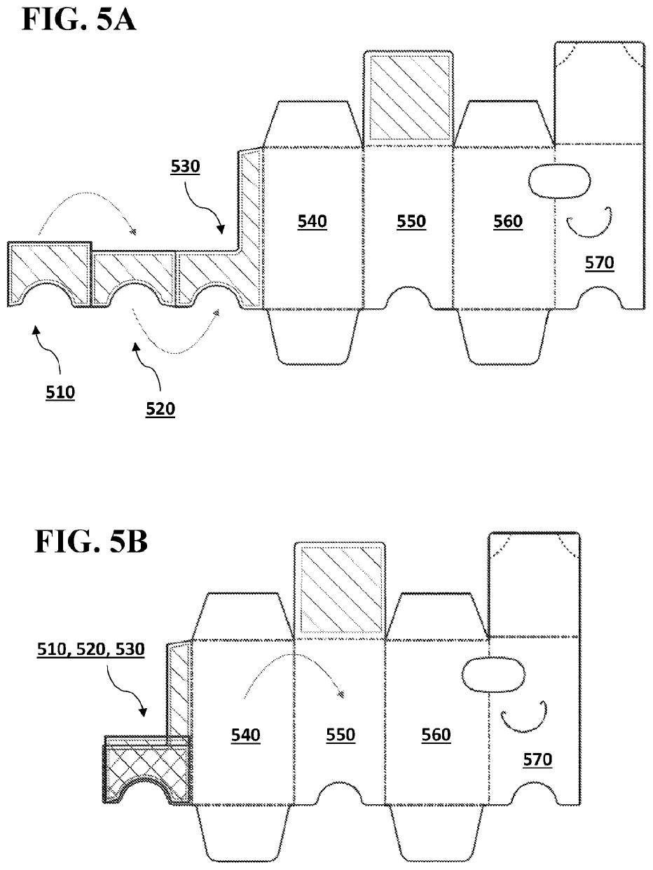

FIGS. 4A and 4B show examples of the outer cover and inner box, respectively, before being folded and assembled. Examples of the primary and secondary flaps 210, 220, button 120, dispensing opening 110, inner flaps 140, and other components are shown for reference and relation to FIGS. 1-3. Although the examples shown herein include illustrative numbers of some components, such as inner flaps, primary/secondary flaps, and a single release button, it will be understood that other numbers may be used without departing from the scope and content of the present disclosure. For example, multiple release buttons 120 may be used, as well as more or fewer flaps and associated locking mechanisms.

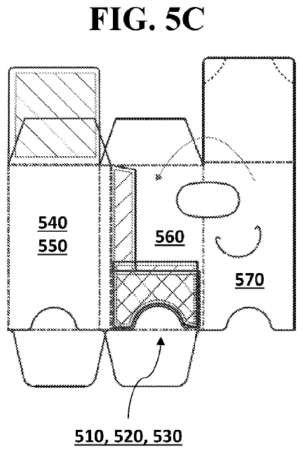

FIGS. 5A-5C show an example process for assembling the outer cover according to embodiments disclosed herein. Dashed lines indicate folds and hashed regions indicate preferred adhesive areas. Beginning at FIG. 5A, a z-fold such as described with respect to FIGS. 3A-3G is assembled by folding panel 520 under to panel 530 and glued. Halfway through this fold, panel 510 is folded over to panel 520 and glued, thereby forming a completed z-fold which may be used as an interior locking mechanism as previously disclosed. Panels 510 and 520, and panels 520 and 530 may be glued to one another.

In FIG. 5B, panel 540 is folded over to panel 550 to result in the arrangement shown in FIG. 5C. Next, panel 570 is folded over to panel 530 and glued to panel 530 to form the flattened outer cover. By applying pressure to the edges, a rectangular solid shape may be formed and held in place by gluing the top portions to form the top of the outer cover as previously disclosed.

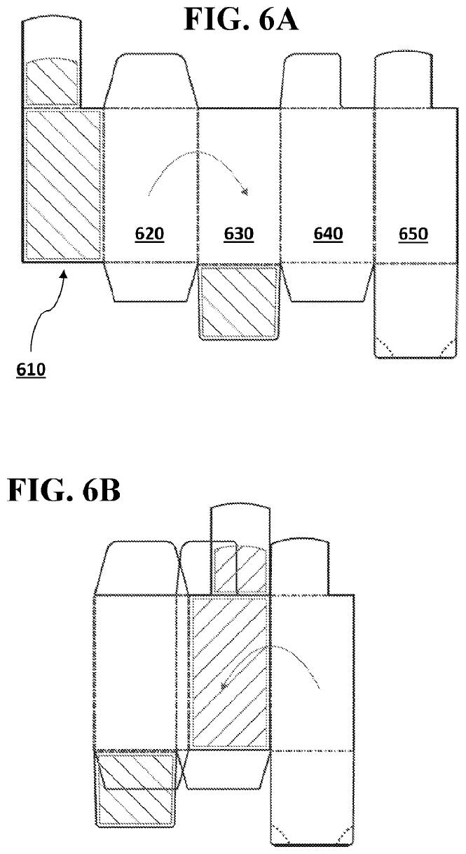

FIGS. 6A-6B shows a similar process for assembling the inner box. Beginning at FIG. 6A, panel 620 is folded over to panel 630 to result in the arrangement shown in FIG. 6B. Panel 650 is then folded over panel 610, which is disposed over panel 640 due to the initial fold shown in FIG. 6A, and glued to panel 610, to form a flattened inner box. By applying pressure to the sides, a rectangular cylinder open at both ends is formed. The top and bottom portions may then be folded over and glued to form the closed inner box. As previously disclosed, flaps at one end of the inner box may include openings to allow for filling the inner box, such as via a corresponding opening in the outer cover.

The outer cover and an inner box may be cut from any suitable desired material, for example using the arrangements shown in FIGS. 4-6. The outer cover may be assembled and fixed in place, for example by folding and adhering the top closed end as shown and described with respect to FIGS. 5A-5C, and the inner box may be folded as shown and described with respect to FIGS. 6A-6B. One or more interior flaps 140 may be folded into the outer cover as shown and described with respect to FIGS. 5A-5C to provide the locking mechanism described herein, though other techniques may be used as well to create a similar z-fold and/or a similar locking mechanism. Any suitable adhesive may be used, which may be selected based upon the material used for the outer cover and/or the inner box.

The components described herein, including the inner box and outer cover, may be fabricated from any suitable material, which may be partially or entirely recyclable or biodegradable. Example materials include paper, cardstock, cardboard, corrugated cardboard, and the like. Example weights for the material include 24-30pt paper, cardstock, or similar material. As a specific example, 24pt paperboard may be used.

The various embodiments, descriptions, and figures disclosed herein are provided by way of example only, and are not intended to limit the scope of the invention. Variations on the specific arrangements and materials may be used without departing from the scope and content of the present disclosure. For example, the specific arrangement of glue lines, folds, seams, material thickness and type, and the like may be varied or modified from the specific examples provided herein. Similarly, various dimensions may be used for the container, including the outer cover and inner box, though it may be preferable for the dimensions generally to match those of a particular industry standard, such as standardized pill bottle dimensions used in the pharmaceutical industry. The position and joint arrangement of various components may be altered, such as the specific position of the z-fold and other layers used to create the locking mechanisms disclosed herein. As a specific example, the z-fold and/or inner portion locking mechanisms may be disposed on any side of the outer cover and/or the inner box, and more than one may be used in the same device. Embodiments may include other variations from the examples and embodiments described herein, as will be apparent to one of skill in the art.

What is claimed is:

1. A device comprising:
an outer cover having a generally extended rectangular shape and being open at one end, comprising:
an opening disposed along an edge or surface of the outer cover;
a relief cut on one side; and
an inner lip along at least one interior edge of the open end; and
an inner box comprising:
a base portion having a generally extended rectangular shape and being open at one end;
a primary flap extending away from the generally rectangular shape along a first edge of the open end in an unfolded configuration; and
a secondary flap extending away from the generally rectangular shape along at least a second edge of the open end in an unfolded configuration;
wherein, when the secondary flap is folded flat against an outer surface of the inner box and the inner box is disposed inside the outer cover, the secondary flap engages with the inner lip to prevent the inner box from being removed entirely from the outer cover.

2. The device of claim 1, wherein, when the primary are folded flat against outer surfaces of the inner box, and the inner box is disposed inside the outside cover, the primary flap engages with an interior portion of the outer cover to prevent the inner box from being partially removed from the outer cover; and when a portion of the outer cover in the region of the relief cut is depressed inward, the inner box is partially removable from the outer cover.

3. The device of any preceding claim, wherein,
when the inner box is partially removed a first amount from the outer cover, the primary flap engages with the interior portion of the outer cover to prevent the inner box from being further removed from the outer cover and the interior portion of the outer cover prevents the portion of the outer cover in the region of the relief cut from being depressed inward; and
when the inner box is partially removed a second amount less than the first amount or disposed within the outer cover to the greatest extent possible, the portion of the outer cover in the region of the relief cut is not prevented from being depressed inward to disengage the primary flap from the interior portion.

4. The device of any preceding claim, wherein, when the inner box is partially removed from the outer cover, the opening disposed along the edge or surface of the outer cover provides access to the interior of the device.

5. The device of any preceding claim, wherein the device is comprised entirely of recyclable material.

6. The device of any preceding claim, wherein the device comprises of paper, paperboard, cardboard, or cardstock.

7. A method of assembling a container, the method comprising:
folding an outer cover in the form of a rectangular box having one open end from a single sheet of foldable material to create a z-fold in the interior of the rectangular box;
folding an inner box from a single sheet of foldable material, the inner box comprising a primary flap extending toward a first end of the inner box and connected to an adjacent face of the inner box via a fold at a second end of the inner box; and
inserting the inner box into the outer cover such that, when inserted into the outer cover, the primary flap engages with the z-fold to prevent the inner box from being removed from the outer cover.

8. The method of claim 7, wherein the outer cover comprises a relief cut forming a button which, when depressed, allows the inner box to be removed at least partially from the outer cover.

9. The method of claim 8, the step of folding the outer cover further comprising folding an inner portion to form a flap projecting inward from an edge of the outer cover at the open end of the outer cover, wherein the inner portion engages with a secondary flap of the inner box to prevent the inner box from being entirely removed from the outer cover.

10. The method of claim 9, the step of folding the inner box further comprising forming the secondary flap by folding a portion of a side of the inner box along an outer portion of the side of the inner box.

11. A method of assembling a container substantially as shown and described.

12. The method of claim 11, wherein the method comprises:
a first process of assembling an outer cover as shown in FIGS. SA-SC and described;
a second process of assembling an inner box as shown in FIGS. 6A-6B and described; and
inserting the inner box into the outer cover.

13. A container device substantially as shown and described.
